(19) United States
(12) Patent Application Publication
(10) Pub. No.: US 2003/0131371 A1
(43) Pub. Date: Jul. 10, 2003

(54) Production of nuclear transfer horse embryos by piezo-driven injection of somatic cell nuclei and activation with stallion sperm cytosolic extract

(76) Inventors: Young Ho Choi, College Station, TX (US); Katrin Hinrichs, College Station, TX (US)

Correspondence Address: James E. Bradley, BRACEWELL & PATTERSON, LLP, P.O. Box 61389, Houston, TX, 77208-1389, US

(21) Appl. No.: 10/304,181

(22) Filed: Nov. 26, 2002

Related U.S. Application Data
(60) Provisional application No. 60/333,362, filed on Nov. 26, 2001.

(51) Int. Cl. A01N 1/02

(52) U.S. Cl. 800/21; 435/2

(57) ABSTRACT

Methods of reconstructing horse and bovine oocytes using direct nuclear injection with a Piezo-driven pipette are provided. Methods of activating horse oocytes are also provided. Further, a crude sperm cytosolic factor from stallion sperm is provided for parthenogenetic activation of horse oocytes and activation of horse oocytes reconstructed with horse somatic cells.

### 1. CROSS-REFERENCE TO RELATED APPLICATIONS

This application is a non-provisonal application, which claims the priority of the U.S. provisional application Serial No. 60/333,362, filed Nov. 26, 2001.

### BACKGROUND OF THE INVENTION

1. Technical Field

The present invention generally relates to molecular biology. More specifically, the present invention relates to production of nuclear transfer horse embryos by Piezo-driven injection of somatic cell nuclei and activation with stallion sperm cytosolic extract.

2. Description of the Related Art

Somatic cell nuclear transfer has been successfully performed in several species, including sheep (Wilmut et al., 1997), mice (Wakayama et al., 1998), cattle (Kato et al., 1998; Wells et al., 1999), goats (Baguisi et al., 1999) and pigs (Onishi et al., 2000; Polejaeva et al., 2000). To reconstruct recipient oocytes with somatic cell nuclei, inactivated Sendai virus, electrofusion and intracytoplasmic direct nuclear injection have been used, with the majority of work being done by electrofusion. In cattle, the rate of reconstruction after electrofusion of host cytoplasts with somatic cells has ranged from 36 to 89% (36-41%, Kubota et al., 2000; 42-59%, Hill et al., 2000; 47-63%, Kato et al., 1998; 55-89%, Kato et al., 2000; 62-74%, Dinnyes et al., 2000; 76%, Zakahartchenko et al., 1999). These rates are lower than those achieved when cloning with embryo-derived blastomeres in the same species (86-99%, Peura et al., 2001; Zakahartchenko et al., 1999). The reported percentages of reconstruction with somatic cells by electrofusion in the pig are 77-81% (Verma et a., 2000) and in sheep, 63-85% (64-85%, Wilmut et al., 1997; 63-64%, Wells et al., 1998). When inactivated Sendai virus is used for fusion, relatively lower fusion rates were reported (43-50%, Kato et al., 1999; 58-69%, Ono et al., 2001). Cytoplasmic direct injection using the Piezo drill, which was introduced by Wakayama et al. (1998), has produced a high reconstruction rate in mouse oocytes (79-95%, Wakayama et al., 1998; 93%, Ogura et al., 2000; 85-94%, Wakayama and Yanagimachi, 2001).

Little information is available on nuclear transfer in the horse. There are no reports of nuclear transfer with embryonic blastomeres in this species. Electrofusion of horse oocytes with adult somatic donor cells has been reported in brief communications, with fusion rates from 20 to 67% (20%, 29/146, Choi et al., 2001; 48%, 28/59, Hinrichs et al., 2000; 67%, 24/36, Regio et al., 2000). Direct injection of nuclei into equine oocytes using a standard pipette has also been reported, with 14 to 30% reprogramming after activation (Li et al., 2000). Cleavage rates after nuclear transfer in horse oocytes were low in these reports (0/24, Reggio et al., 2000; 14% (1/7), Li et al., 2000; 9% (3/34) Choi et al., 2001; 11% (3/28), Hinrichs et al., 2000). In these studies, activation of reconstructed oocytes was achieved by treatment with a calcium ionophore and incubation with cycloheximide or 6-DMAP, or by treatment with calcium ionophore with ethanol (Li et al., 2000).

The cleavage rates achieved in reconstructed embryos using the above-mentioned chemical methods of activation are quite disappointing. Therefore, there is clearly a need for a new method of reconstructing embryos with high cleavage rate. The present invention fulfills this long-standing need in the art.

### SUMMARY OF THE INVENTION

The present invention is directed to a method of reconstructing horse and bovine oocytes using direct nuclear injection with a Piezo-driven pipette. The present invention also provides a method of activating horse oocytes using a stallion sperm cytosolic factor. Further, the present invention provides a crude sperm cytosolic factor from stallion sperm for parthenogenetic activation of horse oocytes and activation of horse oocytes reconstructed with horse somatic cells.

In one embodiment of the present invention, there is provided a method of reconstructing horse oocytes. The method includes first enucleating horse oocytes and then injecting horse somatic cell nuclei into the enucleated oocytes using a Piezo-driven pipette.

In another embodiment of the present invention, there is provided a method of activating horse oocytes by injecting a stallion sperm cytosolic factor into the horse oocytes using a Piezo-driven pipette.

In still another embodiment of the present invention, there is provided a method of reconstrcuting bovine oocytes. The method includes first enucleating bovine oocytes and then injecting horse somatic cell nuclei into the enucleated bovine oocytes.

In yet another embodiment of the present invetion, there is provided a stallion sperm cytosolic factor for activating horse oocytes.

The foregoing and other advantages of the present invention will be apparent to those skilled in the art, in view of the following detailed description of the preferred embodiment of the present invention, taken in conjunction with the accompanying drawings.

### BRIEF DESCRIPTION OF THE DRAWINGS

The novel features believed characteristic of the invention as well as a preferred mode of use, further objectives, and advantages thereof, will best be understood by reference to the following detailed description of an illustrative embodiment when read in conjunction with the accompanying drawings, wherein:

FIG. 1 presents photomicrographs of parthenogenetically activated oocytes in first mitosis (panel A) and cleavage (panel B).

FIG. 2 shows that after nuclear transfer by direct injection and with sperm factor activation, embryos developed to a maximum of 10 nuclei.

### DETAILED DESCRIPTION OF THE PREFERRED EMBODIMENT

The present invention is directed to a method of reconstructing horse oocytes using direct nuclear injection and activating horse oocytes using a stallion sperm cytosolic factor with a Piezo-driven pipette. Also provided is a crude sperm cytosolic factor from stallion sperm for parthenogenetic activation of horse oocytes and activation of horse oocytes reconstructed with horse somatic cells.

Recently a high rate of normal fertilization (71%) and cleavage (72%) after intracytoplasmic sperm injection (ICSI) of horse oocytes using the Piezo drill has been reported (Choi et al., submitted). This high rate of cleavage is in sharp contrast to disappointing cleavage rates achieved in reconstructed embryos using conventional chemical methods of activation. Because sperm appear to be efficient activators of horse oocytes, the activation of reconstructed horse and bovine oocytes was examined with stallion sperm that had been treated with Hoechst 33342 and exposed to UV light to inhibit sperm involvement in the reconstructed embryo (Choi and Hinrichs, unpublished data). The nuclear decondensation rates of horse and bovine oocytes reconstructed with horse somatic cells nuclei and injected with horse sperm were 37% (13/35) and 77% (24/31), respectively. This suggested that factor(s) from sperm have the ability to stimulate activation of horse or bovine reconstructed oocytes. However, after injection some oocytes possessed a decondensed sperm head, or 2 or 3 pronucleus-like formations. An alternative to use an intact sperm is to use cytosolic sperm factor. Sperm factor has been used to parthenogenetically activate mammalian oocytes (Perry et al., 1999; Fissore et al., 1998). Injection of sperm factor has been used to activate oocytes after nuclear transfer in cattle, but with lower efficiency than that achieved with chemical activation (Knott et al., 2001). There are no previous reports on the use of sperm factor for activation of horse oocytes. The present invention demonstrates the dose effect of sperm factors on parthenogenetic activation of horse oocytes and on activation of horse oocytes reconstructed with horse somatic cells.

Because of poor development achieved after nuclear transfer with horse oocytes, the ability of Piezo-injected equine nuclei to control embryonic development was validated by performing transfer of horse somatic cell nuclei into bovine host cytoplasts and monitoring their development. Bovine cytoplasts have previously been shown to develop to the 8 to 16-cell stage after electrofusion with horse somatic cell nuclei (Hinrichs et al., 2000).

In one embodiment of the present invention, there is provided a method of reconstructing horse oocytes. The method includes first enucleating horse oocytes and then injecting horse somatic cell nuclei into the enucleated oocytes using a Piezo-driven pipette.

In another embodiment of the present invention, there is provided a method of activating horse oocytes by injecting a stallion sperm cytosolic factor into the horse oocytes using a Piezo-driven pipette. Preferably, the horse oocytes are either natural oocytes or reconstructed oocytes. For the natural oocytes, the activation is a parthenogenetic activation. For the reconstructed oocytes, e.g., horse somatic cell nuclear transfer oocytes, the injection of the stallion sperm cytosolic factor is an intracytoplasmic injection. Still preferably, the sperm cytosolic factor is injected into the horse oocytes in a dosage range of about 0.5×10⁸ to about 10×10⁸ sperm/ml.

In still another embodiment of the present invention, there is provided a method of reconstrcuting bovine oocytes. The method includes first enucleating bovine oocytes and then injecting horse somatic cell nuclei into the enucleated bovine oocytes.

In yet another embodiment of the present invetion, there is provided a stallion sperm cytosolic factor for activating horse oocytes.

The following examples are given for the purpose of illustrating various embodiments of the invention and are not meant to limit the present invention in any fashion.

### EXAMPLE 1

Oocyte Collection

Ovaries were transported from two slaughterhouses to the laboratory at room temperature (3-4 h transport time). Adnexia were trimmed from the ovaries with scissors and the ovaries were cleaned with sterilized gauze. All visible follicles were opened with a scalpel blade and the granulosa layer of each follicle was scraped using a 0.5 cm bone curette. The contents of the curette were washed into individual petri dishes with Hepes-buffered TCM199 with Hank's salts (Gibco Life Technologies, Inc., Grand Island, N.Y., USA) plus ticarcillin (0.1 mg/ml, SmithKline Beecham Pharmaceuticals, Philadelphia, Pa., USA). The contents of the petri dishes were examined using a dissection microscope at 10-20×. Oocyte-cumulus complexes were classified as compact, expanded or degenerating depending on the expansion of both mural granulosa and cumulus as described previously (Hinrichs and Williams, 1997; Hinrichs and Schmidt, 2000). Oocytes with any sign of expansion of either the cumulus or the mural granulosa, from having individual cells visible protruding from the surface to having full expansion with copious matrix visible between cells, led to the classification of expanded (Ex). Oocytes having both compact cumulus and compact mural granulosa were classified as compact (Cp).

### EXAMPLE 2

In vitro Maturation

Selected oocytes were washed twice in maturation medium (TCM199 with Earle's salts (Gibco), 5 μU/ml FSH (Sioux Biochemicals, Sioux Center, IA, USA), 10% fetal bovine serum (Gibco) and 25 μg/ml gentamycin (Gibco). Oocytes were cultured in droplets at a ratio of 10 μl medium per oocyte, under light white mineral oil (Sigma Chemical Co., St Louis, Mo., USA) at 38.2° C. in 5% CO2 in air for 24-26 h. After maturation, oocytes were denuded of cumulus by pipetting in a solution of 0.5% hyaluronidase in TCM199 with 5% FBS. Denuded oocytes were selected for presence of a polar body. Oocytes not having a polar body were fixed in buffered formal saline, mounted on a slide with 6.5 μl of 9:1 glycerol:PBS containing 2.5 μg/ml Hoechst 33258, and examined using fluorescence microscopy to determine the chromatin configuration.

### EXAMPLE 3

Preparation of Stallion Sperm Cytosolic Factor

Stallion sperm cytosolic factor was prepared as described previously for the mouse (Swan, 1990; Perry et al., 1999) with slight modifications. Ejaculated stallion sperm were centrifuged at 900×g for 10 min to remove seminal plasma. The pellet was then suspended with sp-TALP with 6 mg/ml BSA (Parrish et al., 1988) and centrifuged at 900×g for 10 min. The resulting pellet was resuspended to a density of either 5 or 20×10⁸ sperm/ml in nuclear isolation medium (NIM: 125 mM KCl, 2.6 mM NaCl, 7.8 mM Na₂HPO₄, 1.4 mM KH₂PO₄, 3.0 mM EDTA; pH 7.45, Kuretake et al., 1996) and centrifuged to remove sp-TALP. The pellet was then resuspended to the same volume with NIM containing 1 mM DTT, 100 μM leupeptin, 100 μM antipain, and 100 μg/ml soybean trypsin inhibitor. The suspension was subjected to 4 cycles of freezing (5 min per cycle in liquid N₂) and thawing (5 min per cycle at 15° C.), then sperm were pelleted at 20,000×g for 50 min at 2° C. The resultant supernatant was carefully removed, aliquoted and kept at −80° C. until used.

### EXAMPLE 4

Preparation of Donor Cells

Fibroblast cells were collected from gum tissue of a 4 year-old mare. Pieces of tissue were placed in a flask with DMEM/F-12 (Sigma) supplemented with 10% FBS and 1% antimicrobials (10,000 U/ml penicillin G, 10 mg/ml streptomycin and 25 μg/ml amphotericin B; Sigma). Cells were cultured in 5% CO₂ at 37 to 38.2° C. until fibroblast cells became confluent, and were passaged by trypsinization. For this experiment, cells at passage 3-7, grown to confluence without serum starvation, were used. Cells were trypsinized before use and held in TCM199 plus 10% FBS for nuclear transfer by electrofusion. For direct injection, cells were held in TCM199 plus 2-10% PVP.

### EXAMPLE 5

Statistical Analysis

Differences among groups were evaluated using Chi square analysis, with Fisher's exact test used when the expected value for any parameter was less than 5.

### EXAMPLE 6

Parthenogenetic Activation of Cp Oocytes with Sperm Factor

Matured horse Cp oocytes with the first polar body were selected. Injection of sperm factor was performed using a Piezo drill (Burleigh Instruments Inc., Fishers, N.Y., USA). Sperm factor from 5 and 20×10⁸ sperm/ml preparations were diluted 1:1 in NIM plus 20% PVA, thus representing the equivalent of 2.5 and 10×10⁸ sperm/ml with a final concentration of 10% PVA. For injection of the diluted sperm factor, a pipette with an inner diameter of around 5 μm was used, and the injection volume (1-3 pl) was controlled by the movement of mercury within the pipette (Perry et al., 1999). Injected oocytes were held for 20 min at room temperature in the same medium to heal the broken membrane slowly. Oocytes were transferred into G1.2 medium (G1.2/G2.2, IVF Science, Denver, Colo.) at a ratio of 10 μl medium/oocyte and were incubated at 38.2° C. under 5% CO2 in air. At 20 h post-injection, oocytes were fixed, stained and evaluated as described for in vitro maturation above. Oocytes in anaphase II—metaphase III (metaphase plate with 2 polar bodies) were considered to be activated but arrested in development (having incomplete activation). Oocytes having 1 to 3 pronuclei, syngamy, first, mitotic metaphase, or cleavage with presence of nuclei in each blastomere, with one or two polar bodies, were considered fully activated.

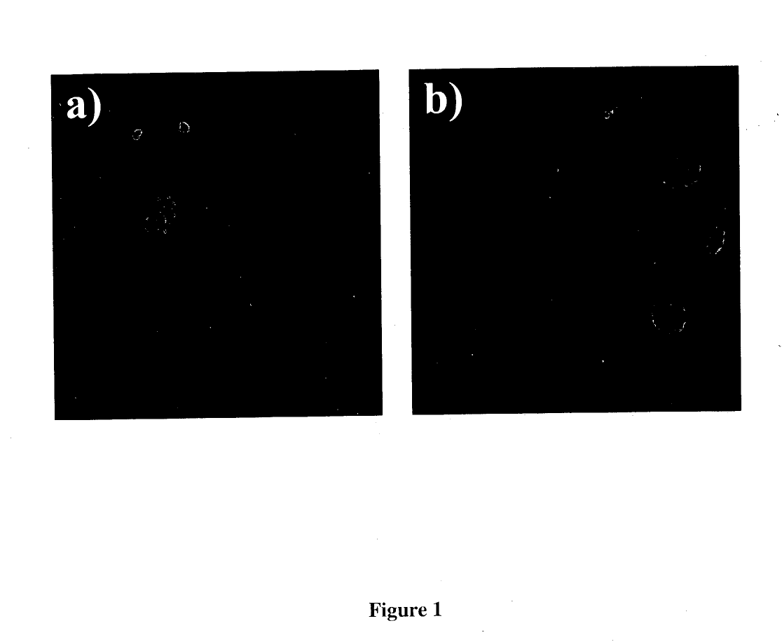

As a result, a total of 313 Cp oocytes were placed into maturation culture for parthenogenetic activation with stallion sperm factor. Of these, 82 (26%) had a first polar body after culture. 80 Cp oocytes were intact after injection of sperm factor and 2 lysed after injection. The activation rates of oocytes treated with the 2.5 or 10×10⁸ dosages of sperm factor were 86% and 88% respectively (Table 1); these were not significantly different. The rates of cleavage with normal nuclei were 48% and 45%, respectively; these were also not significantly different. Photomicrographs of parthenogenetically activated oocytes in first mitosis and cleavage are presented in FIG. 1.

TABLE 1
Parthenogenetic activation of horse oocytes injected with sperm factor and cultured in G1.2
medium for 20 h

| Sperm factor | | No. of | | | | | |
|---|---|---|---|---|---|---|---|
| concentration | No. of | oocytes | No. of oocytes (%) activated with | | | | |
| (×10⁸ sperm/ml) | trials | examined | MIII | 1-3 PN + 1-2PB | 1^{st} Mitosis | Cleaved | Total Activated |
| 2.5 | 7 | 42 | 3 | 9 | 4 | 20 (48%) | 36 (86%) |
| 10 | 6 | 40 | 4 | 4 | 9 | 18 (45%) | 35 (88%) |

MIII, Metaphase plate with 2 polar bodies;
PN, pronucleus;
PB, polar body.

### EXAMPLE 7

Nuclear Transfer by Direct Injection with Sperm Factor Activation

Matured Ex oocytes were selected for presence of a first polar body and were incubated in TCM199 with 10% FBS that contained 5 μg/ml Hoechst 33342 (Sigma) and 5 μg/ml cytochalasin B (Sigma) for 10 min. Oocytes were then held with a holding pipette (120-140 μm outer diameter) under an inverted microscope equipped with Narishige manipulators. The zona pellucida of the oocyte was drilled using an enucleation pipette (10-13 um outer diameter) attached to a Piezo drill (Prime Tech Ltd., Ibaraki, Japan), and the polar body and metaphase plate were aspirated into the enucleation pipette. After enucleation, the resulting cytoplasts were held in TCM199 plus 10% FBS. The injection of fibroblast cells into the enucleated horse oocytes was modified from the method described by Kimura and Yanagimachi (1995), using the Piezo drill. The outside diameter of the injection pipette was 8-9 μm. Immediately before injection, a somatic cell held in TCM199 plus 2-10% PVP was gently aspirated in and out of the injection pipette until the cell membrane was broken. Donor cell injection was carried out in a 100 μl drop of Hepes-buffered TCM199 containing 0.1% polyvinlyalcohol. Reconstructed oocytes were held at 38.2° C. in TCM199 plus 10% FBS in 5% CO₂ in air for 2-10 h before activation.

For activation, reconstructed horse oocytes were subjected to intracytoplasmic injection with 1-3 μl of sperm factor at a concentration representing extract from 0.5, 1.5, 2.5 or 10×10⁸ sperm/ml. These concentrations of solution originated from 5 and 20×10⁸ sperm/ml stock diluted with NIM plus 11-20% PVP to make a final concentration of 10% PVP. Oocytes were injected with sperm factor either 1.5 to 2 hours after donor cell injection, or 8 to 10 hours after donor cell injection. The injection of sperm factor was conducted as previously described for parthenogenetic activation.

Reconstructed, activated oocytes were cultured in a droplet of 10 μl per oocyte in G1.2 medium in 5% CO₂ in air at 38.2° C. for 96 h, without a change of medium. Development of embryos was evaluated daily using a dissection microscope at 40 to 60× magnification, on a heated stage. At 48 h post-activation, non-cleaved embryos were removed, fixed, and stained to examine their activation status. After 96 h of culture, embryos were fixed and stained as described above to examine the number and status of nuclei. Only nuclei which appeared to be normal were included in the nucleus number; nuclei showing signs of degeneration (vacuolization, condensation, or fragmentation) were disregarded.

As a result, a total of 352 horse ovaries were processed, and 3438 follicles were scraped, for an average of 9.8 follicles per ovary. 1829 oocytes were recovered, of which 534 were Cp, 1166 were Ex, and 129 were degenerating. 823 Ex were used for this study, and the remainder were used on a separate project.

When the Ex oocytes were examined after maturation for 24-26 h, 11 were broken during denuding and 812 were evaluated for presence of a polar body. Of these, 489 (60%) had a polar body and 488 were used for nuclear transfer. Of oocytes without polar bodies, 50 were found to be in MI on fixation and staining and the remainder were degenerating.

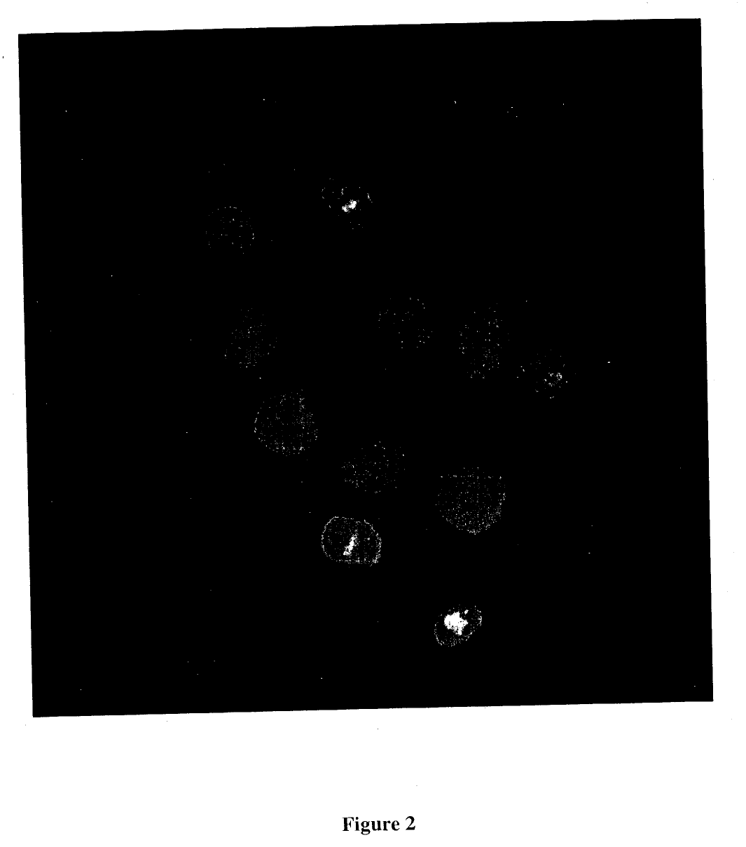

The 488 mature horse oocytes were subjected to enucleation and nuclear transfer with direct injection using the Piezo-driven pipette. Of these, 436 (89%) were successfully enucleated and 399 (82%) survived injection of the donor cell nucleus. The in vitro development of reconstructed horse oocytes activated with different sperm factor concentrations is shown in Table 2. Cleavage and activation (pronucleus-like formation) rates of oocytes injected with the 0.5×10⁸ sperm/ml preparation were significantly (P<0.05) lower than any other dosage. The percentage of embryos cleaving with normal nuclei in oocytes injected with the 10×10⁸ sperm/ml preparation 1.5-2 h after donor injection was significantly (P<0.05) higher than that of the 2.5×10⁸ sperm/ml preparation 8-10 h after donor injection (22 vs. 6%). Embryos developed to a maximum of 10 nuclei (FIG. 2). There was no significant difference in average number of nuclei in embryos from the different sperm factor treatments.

TABLE 2
In vitro development of reconstructed horse oocytes with somatic cell donor nuclei for 96 h after
activation with stallion sperm cytosolic factor

| | 4S | | | | No. (%) of | Average | No. (%) |
|---|---|---|---|---|---|---|---|
| Time of | concentration | | No. of | No. (%) | cleaved | nuclei | of |
| oocyte | (×10⁸ | No. of | oocytes | of oocytes | oocytes with | number | activated |
| Activation | sperm/ml) | replicates | cultured | cleaved | normal nuclei | (Mean ± SEM) | oocytes |
| 1.5-2 h | 0.5 | 4 | 45 | 5 (11)^{a} | 4 (9) | 2.0 ± 0.4 | 11 (24)^{a} |
| after | 1.5 | 4 | 49 | 19 (39)^{b} | 6 (12) | 2.7 ± 0.3 | 26 (53)^{b} |
| injection | 2.5 | 5 | 55 | 26 (47)^{b} | 7 (13) | 2.7 ± 0.6 | 39 (71)^{b} |
| | 10 | 3 | 50 | 23 (46)^{b} | 11 (22)^{c} | 3.5 ± 0.7 | 28 (56)^{b} |
| 8-10 h | 2.5 | 4 | 47 | 20 (43)^{b} | 3 (6)^{d} | 3.3 ± 0.9 | 34 (72)^{b} |
| after | 10 | 4 | 47 | 24 (51)^{b} | 5 (11) | 4.4 ± 1.4 | 27 (57)^{b} |
| injection | | | | | | | |

Donor cell injection with 2-10% PVP, FS injection with 4-10% PVP
^{a} vs. ^{b}: P < 0.01;
^{c} vs. ^{d}: P < 0.05.

### EXAMPLE 8

Nuclear Transfer Using Bovine Host Cytoplasts

Bovine oocytes were purchased from Ovagenics (San Angelo, Tex., USA) and were cultured overnight in a portable incubator maintained at 39° C. Upon arrival at the laboratory, the glass tube containing the oocytes was uncapped and placed in an incubator in 5% CO₂ in air, until 24 h of IVM. Oocytes were then denuded by gentle pipetting in 0.05% hyaluronidase (Sigma) in TCM199 plus 5% FBS. Oocytes with a 1st polar body were selected and used for either electrofusion or direct injection. For the electrofusion method, a beveled glass pipette (20 μm outer diameter) was used for enucleation and insertion of the donor cell into the perivitelline space. Fusion was induced by two DC pulses of 1.9 kv/cm for 25 μsec each by a BTX Electrocell Manipulator 200 (BTX, San Diego, Calif.). After the electrical stimulus, the reconstructed oocytes were cultured for a period of 3 h in TCM plus 10% FBS before activation. Direct injection was performed as described above, using the Prime Tech Piezo drill, with the exception that TCM199 plus 10% PVP was used for donor cell holding and TCM199 plus 10% FBS for intracytoplasmic direct injection of the donor cell.

Activation of bovine oocytes reconstructed by both methods was by treatment with 10 μM calcium ionophore A23187 (Sigma) in TCM199 without serum for 5 min. Oocytes were then washed in TCM199 plus 20% FBS and incubated for 8-10 h in 10 μg/ml cycloheximide in TCM199 plus 10% FBS. To examine the developmental capacity of reconstructed bovine oocytes with horse somatic cell donor nuclei, oocytes were cultured for 3.5 to 5.5 days in G1.2/2.2 media and were fixed and stained to examine numbers of nuclei as described above.

As a result, 373 bovine oocytes were shipped, and 25 oocytes were lost during denuding. After denuding, 294 of 348 oocytes (84%) were selected for nuclear transfer. The enucleation rates for the electrofusion group and Piezo-direct injection group were not significantly different (98 and 93%, respectively, Table 3). However, the rates of successful recombination with donor cell nuclei were significantly higher for the Piezo group than for the electrofusion group (81 vs. 43%, respectively; P<0.001). The in vitro development of reconstructed bovine oocytes cultured for 3.5 to 5.5 days after NT is shown in Table 4. Cleavage rates assessed morphologically were not different between electrofusion and Piezo treatments (80 vs. 88%). The proportions of oocytes cleaving with normal nuclei and >8 nuclei were also not significantly different between the two treatments.

TABLE 3
Reconstruction efficiency of bovine oocytes with horse somatic cell
donor nuclei by electrofusion and direct injection

| | | | | No. (%) |
|---|---|---|---|---|
| | | No. of | No. (%) of | of oocytes |
| | No. of | oocytes | oocytes | successfully fused |
| Reconstruction | replicates | manipulated | enucleated | or injected |
| Electrofusion | 3 | 136 | 133 (98) | 58 (43) a |
| Direct injection | 4 | 159 | 148 (93) | 128 (81) b |

a vs. b; P <0.001.

TABLE 4
In vitro development of reconstructed bovine oocytes
with horse somatic cell donor nuclei

| | | No. of | No. (%) of | No. (%) of | No. (%) of |
|---|---|---|---|---|---|
| | No. of | oocytes | oocytes | embryos with | embryos with |
| Reconstruction | replicates | cultured | cleaved | nuclei | >8 nuclei |
| Electrofusion | 3 | 55 | 44 (80) | 43 (78) | 14 (25) |
| Direct injection | 4 | 82 | 72 (88) | 60 (73) | 34 (41) |

### EXAMPLE 9

Conclusion and Discussion

In this study, Piezo-actuated microinjection resulted in a higher rate of reconstruction of horse oocytes with horse somatic cell nuclei than that previously obtained using electrofusion (82% in this study vs. 20-48%, Hinrichs et al., 2000; Choi et al., 2001). This recombination rate, produced by direct injection, is higher than any previously reported in the horse. Further, the reconstruction rate when bovine oocytes were injected with horse somatic cell nuclei was higher than that reported by Dominko et al. (1999) for other interspecies nuclear transfers, except the combination of bovine oocytes and monkey donor cells. In mouse oocytes, Piezo-driven microinjection also produced higher reconstruction rates than did electric- or virus-mediated fusion (Wakayama et al., 1998; Kato et al., 1999; Ogura et al., 2000; Ono et al., 2001).

There have been only a few reports on methods of activation of horse oocytes either parthenogenetically (Hinrichs et al., 1995; Choi et al., 2001) or after intracytoplasmic sperm injection (Li et al., 2000). In these reports, activation was attempted by exposure to chemicals including ionomycin, ethanol, thimerosal, InsP3, and calcium ionophore A23187, alone or with combination of cycloheximide. The highest rate of activation (52% pronucleus formation plus 24% first mitosis) was achieved by treatment with calcium ionophore A23187 followed by culture in cycloheximide (Choi et al. 2001a). However, when a similar protocol was used to activate reconstructed horse oocytes, only 29% activation and 9% cleavage was obtained (Choi et al., 2001b). In the present study, injection of sperm cytosolic factor into MII horse oocytes resulted in 86-88% total parthenogenetic activation, including 45-48% normal cleavage. Injection of sperm factor was similarly effective in recombined equine oocytes, as a 72% activation rate (combined nuclear decondensation and cleavage) and up to 51% cleavage rate was achieved. These activation and cleavage rates are higher than any other previous report in horse nuclear transfer embryos. However, the percentage of nuclear transfer embryos with normal nuclei after 4 days of culture was low (6 to 22%). To determine whether use of the Piezo drill, or methods associated with this technique, were compromising the ability of the equine somatic cell nuclei to drive normal embryonic development, use of the Piezo drill was compared to electrofusion for transfer of equine nuclei to bovine cytoplasts. Good cleavage and embryo development were obtained using both recombination methods (73-78% normal cleavage, 25 to 41% of embryos with >8 nuclei, Table 3). It is notable that markedly better development was achieved in the interspecies transfer than in the equine-equine transfer. Hinrichs et al. (2000) reported a similar increase in development when bovine cytoplasts rather than equine cytoplasts were used as recipients of equine somatic cell nuclei.

There is one previous report on the use of sperm factor for inducing activation of reconstructed oocytes with adult fibroblast nuclei (bovine; Knott et al., 2001). In that study, in vitro development of oocytes injected with sperm factor after cloning was lower than that for chemically activated or in vitro fertilized oocytes. These authors used 5 μg/ml of cytochalasin B for 3-4 hours after activation to prevent extrusion of the second polar body. The effect of cytochalasin B was not examined in the present study. Further study of cytochalasin B in combination of sperm factor in horse reconstructed oocytes is warranted. In parthenogenetically activated horse oocytes, which were not treated with cytochalasin B, sperm factor induced a high proportion of haploid embryo production as estimated by extrusion of the second polar body (63-75%). However, these embryos were successful in achieving normal cleavage with nuclei present in each blastomere.

The time of oocyte activation after donor injection is an important factor in the success of nuclear transfer. In the mouse, embryo development of oocytes activated 1-6 hr after donor injection is significantly higher than that of simultaneously activated oocytes (Wakayama et al., 1998). These authors reported that chromosome condensation of donor nuclei occurred within 1 hour of injection. The high MPF level within the recipient cytoplast is thought to trigger nuclear membrane break down and condensation of the chromatin into individual chromosomes. It is felt that exposure to the oocyte cytoplasm is important in reprogramming of the chromatin. No information is available on the effect of time from recombination to activation in horse nuclear transfer oocytes. The present study shows that there was no difference in embryo development in oocytes activated 1.5 to 2 hr vs. 8 to 10 hr after recombination when the same dosage of sperm factor was used.

The present study shows that good recombination rates and embryo development can be obtained using the Piezo drill for recombination. Live piglets have been born after microinjection of fetal fibroblast nuclei into enucleated oocytes using the Piezo drill (Onishi et al., 2000). However, microinjection of oocytes using the Piezo drill is technically more difficult than is electrofusion. Ogura et al. (2000) showed in mouse oocytes that nuclear transfer by electrofusion could be an alternative method when injection of donor nuclei into recipient oocytes is technically difficult. They reported similar embryo development between the two methods. In cattle, using a conventional microinjection system, Trounson et al. (1998) suggested that direct injection of nuclei into enucleated bovine oocytes is more efficient than is electrofusion, and the results of the interspecies transfers in the present study support this conclusion. Zhou et al. (2001) found similar embryo development in vitro in embryos reconstructed using the two methods, although early cleavage of embryos reconstructed with direct injection was lower than that with electrofusion. In contrast, the proportion of interspecies embryos (horse nuclei into bovine cytoplasts) which developed past the 8-cell stage in the present study was higher for embryos produced by direct injection using the Piezo drill than for embryos produced by electrofusion, although not significantly so (41% and 25%, respectively).

In conclusion, injection of stallion sperm cytosolic factor activated MII horse oocytes with high efficiency and normal cleavage. Injection of stallion sperm factor also resulted in good activation rates in recombined horse oocytes, but rates of normal cleavage were low. Piezo-actuated microinjection allowed high recombination rates in horse oocytes, and improved recombination rates over use of electrofusion for interspecies (horse-bovine) cloned oocytes. The cleavage rate and extent of embryonic development of interspecies cloned embryos produced by direct injection was equivalent to that for embryos produced by electrofusion. Further research on factors influencing in vitro development of equine nuclear transfer embryos is needed to improve the efficiency of this procedure in the horse.

Any patents or publications mentioned in this specification are indicative of the levels of those skilled in the art to which the invention pertains. Further, these patents and publications are incorporated by reference herein to the same extent as if each individual publication was specifically and individually indicated to be incorporated by reference.

Although the invention has been described with reference to specific embodiments, this description is not meant to be construed in a limiting sense. Various modifications of the disclosed embodiment, as well as alternative embodiments of the invention, will become apparent to persons skilled in the art upon reference to the description of the invention.

What is claimed is:

1. A method of reconstructing horse oocytes, the method comprising the steps of:
enucleating horse oocytes; and
injecting horse somatic cell nuclei into the enucleated horse oocytes using a Piezo-driven pipette thereby reconstructing horse oocytes.

2. A method of activating horse oocytes, the method comprising the step of:
injecting a stallion sperm cytosolic factor into horse oocytes using a Piezo-driven pipette thereby activating horse oocytes.

3. The method of claim 2, wherein the horse oocytes are selected from the group consisting of natural oocytes and reconstrcuted oocytes.

4. The method of claim 3, wherein the activation of natural oocytes is a parthenogenetic activation.

5. The method of claim 3, wherein the reconstructed oocytes are somatic cell nuclear transfer oocytes.

6. The method of claim 5, wherein the injection of the stallion sperm cytosolic factor into the reconstructed oocytes is an intracytoplasmic injection.

7. The method of claim 2, wherein the stallion sperm cytosolic factor is injected into the horse oocytes in a dosage range of about 0.5×10⁸ to about 10×10⁸ sperm/ml.

8. A stallion sperm cytosolic factor for activating horse oocytes.

9. A method of reconstructing bovine oocytes, the method comprising the steps of:
enucleating bovine oocytes; and
injecting horse somatic cell nuclei into the enucleated bovine oocytes using Piezo-driven pipette thereby reconstructing bovine oocytes.
